(19) United States
(12) Patent Application Publication
(10) Pub. No.: US 2024/0127976 A1
(43) Pub. Date: Apr. 18, 2024

(54) METER REPLACEMENT SYSTEM

(71) Applicant: Otto Fest, Tucson, AZ (US)

(72) Inventor: Otto Fest, Tucson, AZ (US)

(21) Appl. No.: 17/832,626

(22) Filed: Jun. 4, 2022

Related U.S. Application Data
(60) Provisional application No. 63/122,565, filed on Jun. 4, 2021.

(51) Int. Cl. G21D 1/02

(52) U.S. Cl. CPC G21D 1/02

(57) ABSTRACT

A single movement display meter includes a display input wherein the display input receives and transmits a display input signal containing information relative to only one property. A digital display is positioned to receive the display input signal and represent the digital input signal within a display, wherein the digital display has a front surface. A display filter mounts on the front surface of the digital display. A hub includes an input connector connectable to one or more wires to receive a hub input signal. A signal modification module connected to the input connector is capable of modifying the hub input signal to output the display input signal. A hub output communicates with the display input to transmit the display input signal.

### STATEMENT OF GOVERNMENT INTEREST

This invention was made with United States government support under contract number ______ awarded by the ______. The United States government has certain rights in this invention.

### CROSS REFERENCE TO RELATED APPLICATION

This application claims benefit of U.S. Provisional Application Serial No. 63,122,565, entitled, “Plug and Play Digital Panel Meters Replaces 100% Form, Fit, & Function Analog Meters” filed Jun. 4, 2021, the entire disclosure of which is incorporated herein by reference.

### FIELD OF THE DISCLOSURE

The present disclosure is generally related to meters and more particularly is related to meter replacement systems.

### BACKGROUND OF THE DISCLOSURE

Many industrial, commercial, and military facilities use numerous meters, gauges, and other reading devices to measure or determine various properties of the facility's operation. For instance, a nuclear power plant with one reactor may typically use between 300-800 meters to allow workers to read various properties of nuclear power generation, such as temperature, pressure, flow rate, electrical output, or many other properties of the facility's operation. However, in many of these facilities, the meters were first installed when the facility was originally built, and as such, the meters are outdated or obsolete analog meters. In nuclear power plants, for instance, the meters in the control rooms are usually between 30-50 years old. Because these meters are so outdated, there are very few, if any, manufacturers or suppliers who can replace or repair them when needed. When one of these meters falls into disrepair, it is very difficult to repair it to a working state again. As such, there exists a continually growing problem with the obsolescence of the instrumentation in the control room of an industrial facility.

To overcome these problems, some industrial, commercial, or military facilities may be required to fully renovate their control rooms to remove the existing outdated analog meters and replace them fully with new, computer-controlled sensors and meters. However, for many facilities, such as nuclear power plants, they are too old and have too short of a life expectancy to justify fully overhauling their control rooms, nor do they have the money to invest in the facility. Instead, they must rely on fixing and replacing individual meters when they stop functioning as needed. This problem is often present in nuclear power plants, in water treatment plants, military installations, and ocean vessels.

However, a typical facility which uses these meters may have upwards of 500 meters, and of those meters, there may be 5-10 different sizes and shapes for the meters. As such, within the conventional art, there is not one single meter design which can function for the varying sizes and shapes of the meters. Additionally, there are usually 30-40 different input signals received by the meters, including, for example, temperature, pressure, humidity, volts, amps, frequency, and others. While some facilities have spare meters in storage to use for replacing malfunctioning meters, the scale visible on the meter's faceplate (on its visible front side) also needs to match the property of which the meter is measuring. For instance, a voltage meter having a voltage scale would need to be replaced with another voltage meter having the same voltage scale, and not a meter having a scale with percentage, or a different minimum/maximum, or a pressure range. Thus, despite that fact that the meters in these facilities may be similar in original design, these other factors often prevent convenient and affordable replacement of a meter.

In one aspect of the invention, a replacement meter system is provided having a meter housing and mounting assembly adaptable for retrofit within any instrument panel. The retrofit can be accomplished without any modifications to the instrument panel, wiring, or display, and can be installed by personnel without special training.

In another aspect of the invention, a replacement meter system is provided having a universal signal conditioning module insertable within the housing and mounting assembly and having “plug in” signal conditioners capable of receiving a wide range of input signals. The module allows for the automatic determination of wether the meter is “loop powered” or externally powered, and allows for a plug in power module for meters requiring external power.

In another aspect of the invention, a method of replacing one or more meters in an instrument panel is provided. The method involves the steps of selecting a meter housing and mounting assembly that fits the space in the instrument panel; selecting the grade (nuclear, military, or industrial) of the meter; selecting an appropriate sized and configured adapter plate if the selected meter housing is different than the old meter housing, the adapter plate part of the mounting assembly; selecting a plug in signal conditioning module based on the input signal; selecting a plug in power module if the meter requires external power; and selecting a scale plate or display filter to be affixed to the front face of the meter housing, the display filter corresponding to the parameter to be measured by the meter. Additional steps may be taken to further customize the replacement meter. The method, using the adapter plate, plug in signal and power modules, and display filter, allows for replacing meters of virtually any size or shape in an instrument panel without the need for soldering or rewiring thereby greatly saving installation time and effort. Also, once the appropriate adapter plate is determined, the installer only need know the input signal and power requirements, and the parameter to be measured so that the installer needs no special training.

In another aspect of the invention, the front surface of the meter housing is a neutral white color to allow for the visualization of the indicia and coloring of a display filter. The translucent display filter is affixed to the front surface of the meter either by adhesive or mechanical means and is used to the indicate the parameter being measured, e.g., volts, the neutral white color of the front surface of the meter housing allowing the relatively dark indicia on the display filter to be viewable.

In another aspect of the invention, the replacement meter system that avoids the use of devices/components that require firmware or software subject to criminal breach. The hardware only design of the present invention meets strict requirements of the industry to reliably and accurately operate within the present limited power available to analog meters technology such as 1-5 and mainly 4-20 mA current loops as well as alternating current known as household power and direct current used in industrial applications, just like present analog meters do and also externally powered meters used for sub-microwatt applications.

### SUMMARY OF THE DISCLOSURE

Embodiments of the present disclosure provide a system and method for providing a single movement display meter. Briefly described, in architecture, one embodiment of the system, among others, can be implemented as follows. A single movement display meter includes a display input wherein the display input receives and transmits a display input signal containing information relative to only one property. A digital display is positioned to receive the display input signal and represent the digital input signal within a display, wherein the digital display has a front surface. A display filter mounts on the front surface of the digital display. A hub includes an input connector connectable to one or more wires to receive a hub input signal. A signal modification module connected to the input connector is capable of modifying the hub input signal to output the display input signal. A hub output communicates with the display input to transmit the display input signal.

The present disclosure can also be viewed as providing methods of providing a single movement display meter. In this regard, one embodiment of such a method, among others, can be broadly summarized by the following steps: receiving a display input signal with a display input, wherein the display input signal contains information relative to only one property; receiving the digital input signal from the display input with the digital display, wherein the digital display has a front surface; and mounting a display filter to the front surface of the digital display.

The present disclosure can also be viewed as providing methods of systematically replacing one or several meters in an instrument panel. The method, in one embodiment, allows for the efficient and relatively inexpensive replacement of multiple meters in a facility by providing a highly adaptable and configurable meter system having interchangeable components. The appropriate interchangeable components are easily determined by the installer, and the installation can be accomplished without specialized training or detailed installation instructions. Once the physical mounting requirements are known, the method provides for “plug and play” installation with plug in modules providing signal conditioning and power. In other embodiments of the method, additional steps are taken to further customize the replacement meter.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1-3 are illustrations of a meter and display filters of the meter replacement system, in accordance with a first exemplary embodiment of the present disclosure.

FIG. 4 is an exploded view illustration of a meter replacement system, in accordance with the first exemplary embodiment of the present disclosure.

FIG. 5 is a partial cross-sectional view illustration of the meter replacement system of FIG. 4 in accordance with the first exemplary embodiment of the present disclosure.

FIG. 6 is a front view illustration of various adapter plates for use with the meter replacement system, in accordance with the first exemplary embodiment of the present disclosure.

FIG. 7 is a schematic diagram of the hub and the meter, in accordance with the first exemplary embodiment of the present disclosure.

FIG. 8 is a simple schematic electrical drawing of the analog/digital conversion as applied to the present disclosure.

FIG. 9 is a simple schematic electrical drawing of a signal convertor as applied to the present disclosure.

FIG. 10 is an illustration of a schematic for power conversion in accordance with the single movement meter system of the present disclosure.

FIG. 11 is an illustration of a schematic for an input/output module of the signal modification module.

FIG. 12 is an illustration of a schematic for an automatic detection of either loop power or external power in accordance with the single movement meter system of the present disclosure.

FIGS. 13 and 14 are illustrations of schematics for Proportional Integral Derivative (PID) modules in accordance with the single movement meter system of the present disclosure.

FIG. 15 is a flowchart illustrating a method of operating a single movement display meter in accordance with the first exemplary embodiment of the disclosure.

### DETAILED DESCRIPTION

To overcome the aforementioned problems in the conventional art, the subject disclosure is directed to improvements for meters, including mechanical and electrical components for the repair and replacement of meters. In particular, the subject disclosure is directed, in part, to a retrofittable meter replacement system which allows for convenient and efficient replacement of a conventional meter which has malfunctioned or otherwise needs replacement.

FIGS. 1-3 are illustrations of a single movement display meter 10 and display filters 20 of the meter replacement system, in accordance with a first exemplary embodiment of the present disclosure. In particular, FIG. 1 illustrates a single movement display meter 10, which is characterized as a meter, regardless of size and shape, that provides data on one property. The data is displayed on a front surface 12. The single movement display meter 10 is a meter that may operate with movement from an input of 1 milliamp (mA) DC. As such, regardless of the property the meter 10 is used to identify, e.g., voltage, temperature, pressure, etc., the output of the single movement display meter 10 is based on the 1 mA DC display input.

For the single movement meter 10, the movement displayed on the single movement display meter 10 may be an illuminated display bar 14, as shown in FIG. 1. The illuminated display bar 14 may be white in color. The color of the illuminated display bar 14 may be adjustable. Based on the display input to the meter 10, the display bar 14 illuminates to various positions along its length or size, such as to various locations along the curved shape of the display bar 14, as illustrated. The illuminated portion of that curved shape may thus represent the value of the parameter being measured by the single movement display meter 10. The single movement display meter 10 may alternatively or also have a digital display 16 which visibly shows data. Other representations of data may also be adopted without departing from the scope of the present disclosure. Since the single movement display meter 10 is based on the single movement of the 1 mA and uses a substantially consistent display bar 14, the single movement display meter 10 may largely be universally used to replace malfunctioned conventional meters.

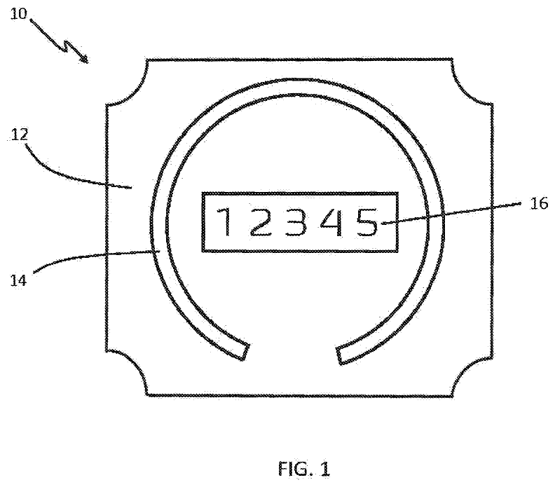

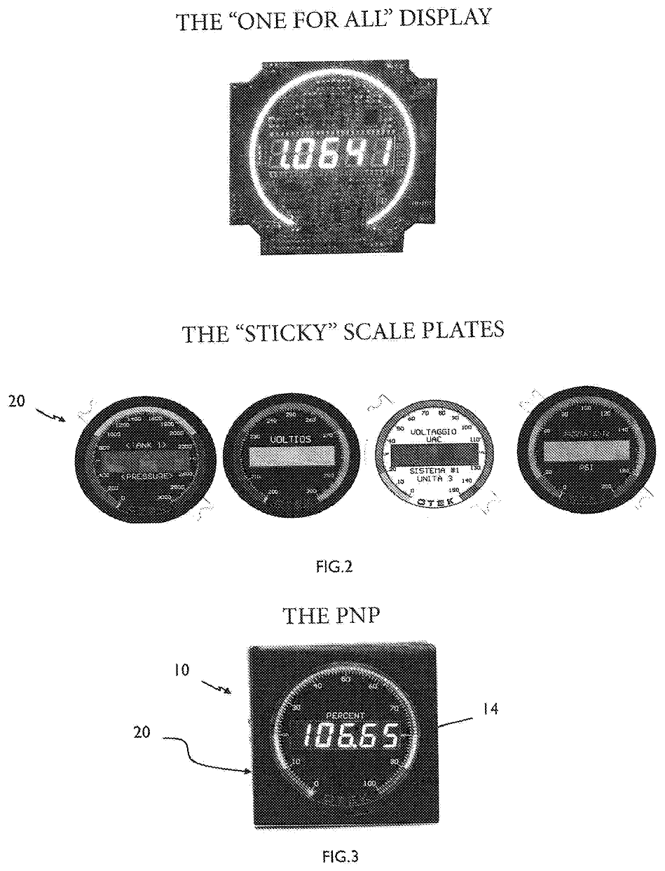

To use the single movement display meter 10 with a specific parameter, such as to display an electrical measurement, a pressure measurement, or a similar parameter, a display filter 20 is attachable to the front surface 12 of the single movement display meter 10. Various display filters 20 are illustrated in FIG. 2. As illustrated, the display filter 20 may be a semi-transparent piece of plastic or other material which has textual and pictographic images along with optional colors, all of which can be used to provide the scale and/or information about a reading on the meter 10. For example, the display filter 20 may have darkened indicia imprinted thereon such as e.g., “volts”, which identifies and quantifies the parameter that the display filter corresponds to. It may also have a colored, semi-transparent portion which corresponds to the display bar 14, such that when it is illuminated, it is visually seen by a user as a certain color. Colors in the display filter 20 that sit over the illuminated display bar 14 may include green, yellow, and red to represent the urgency of the data visually. Various numerical information may be located along the display bar 14 portion of the display filter 20 to indicate units of the parameter that the display bar 14 shows. FIG. 3 illustrates a meter 10 with a display filter 20 attached thereto, such that when the display bar 14 illuminates, the parameter value can be visually displayed.

The use of the display filter 20 may provide significant benefits in the industries where meters require replacement. When desired, a user can replace a malfunctioning meter with a single movement display meter 10, and then select the appropriate display filter 20 for the parameter that the single movement display meter 10 measures. Accordingly, a user who requires a pressure meter would put a pressure display filter 20 over the single movement display meter 10, such that when the display bar 14 is illuminated, a user could identify the pressure on the single movement display meter 10. With this single movement display meter 10 and the variety of display filters 20, any identical size and shape of the meters 10 can be used with any property detection or measurement. Additionally, because the display filter 20 is placed on the outside of the front surface 12 of the single movement display meter 10, versus conventional meters where the display is factory sealed within the housing of the meter, it is easy to change the display filter 20 when re-purposing the single movement display meter 10.

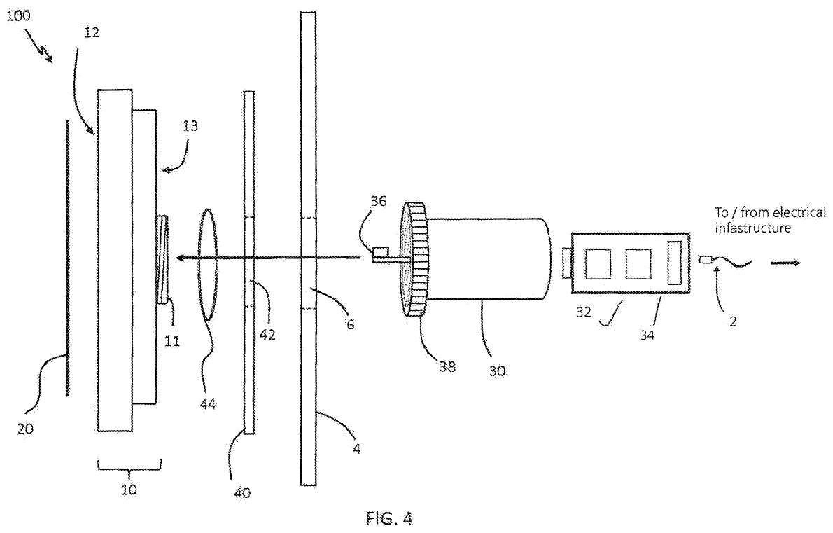

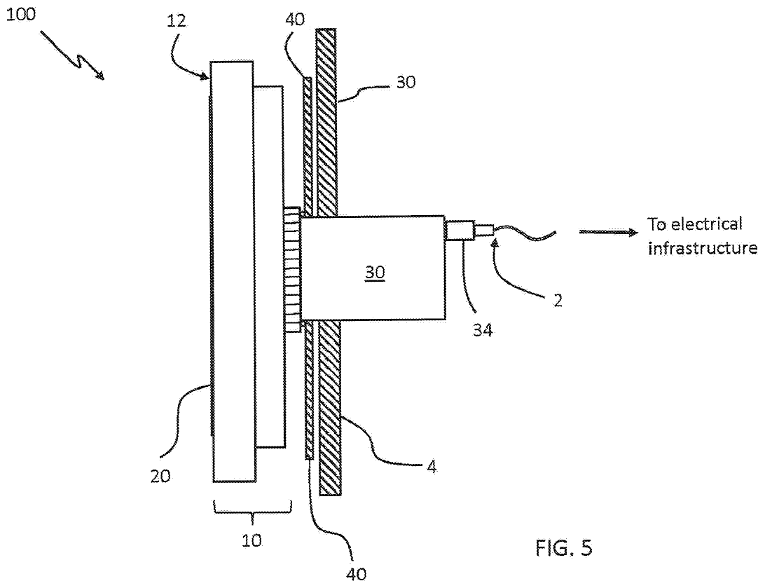

In order to utilize the single movement display meter 10 in the desired physical setting, the meter replacement system may include the use of a hub 30 and an adapter plate 40 which provide the electrical and mechanical connections between the single movement display meter and electrical and mechanical infrastructure of the facility, respectively. FIG. 4 is an exploded view illustration of a meter replacement system 100, in accordance with the first exemplary embodiment of the present disclosure, and FIG. 5 is a partial cross-sectional view illustration of the meter replacement system 100 of FIG. 4 in accordance with the first exemplary embodiment of the present disclosure. As shown, the meter replacement system 100 includes a hub 30 or hub assembly. The hub 30 includes an input connector 34 to receive a hub input signal from electrical infrastructure 2 of the facility, such as a signal wire from one or more sensors. The hub includes a signal modification module 32, which may include one or more printed circuit boards. The signal modification module 32 is capable of modifying the hub input signal to output a signal to the single movement display meter 10 that is within acceptable input parameters of the single movement display meter 10. Once modified, a hub output port 36 is in communication with the display input (not shown), and transmits the display input signal to the single movement display meter 10.

The hub 30 may have various shapes, but in one example, the hub 30 is substantially cylindrical such that it can fit through one or more adapter plates 40 which aids in mounting the hub 30 to the single movement display meter 10. In particular, the body of the hub 30 may be positioned through a central aperture 42 of the adapter plate 40 such that the output port 36 of the hub 30 can engage with a display input located on a rear side 13 of the single movement display meter 10. The electrical connection between the hub output port 36 and the display input may be achieved by any known electro-mechanical connections, such as by threading a holding nut 38 or collar of the hub 30 on to a threaded receiver 11 on the single movement display meter 10, whereby the mechanical connection (threaded, friction-fit, biased, or otherwise) ensures an electrical connection between the hup output port 36 and the display input. In this position, the hub 30 is also positioned through an aperture 6 of an existing panel 4 within the facility, thereby allowing the single movement display meter 10 and hub 30 to be mechanically retained in the desired location for display to a user. For example, the existing panel 4 may be located within the control room of the facility, such that the meter replacement system 100 can be used to provide a new, working meter in the same panel 4 as the meter that required replacement. Optionally, one or more gaskets or O-rings 44 may be used to ensure a tight mechanical connection and prevent the intrusion of foreign contaminants, e.g., moisture, dust, etc. into any of the electrical connections. FIG. 5 illustrates a partial cross-sectional view of the meter replacement system 100 with the hub 30 in an installed position with the display filter 20 located on the front surface 12 of the single movement display meter 10.

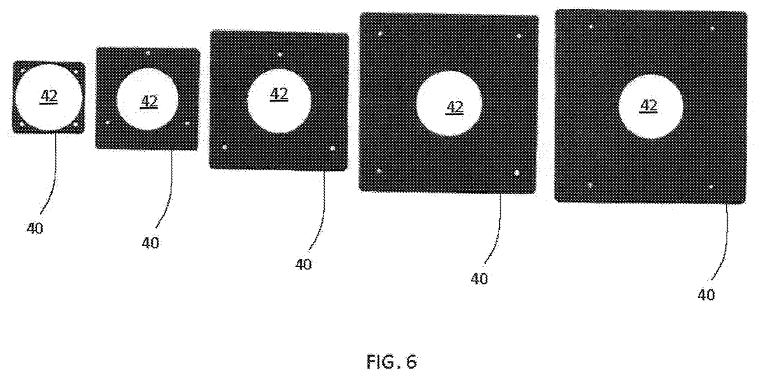

FIG. 6 is a front view illustration of various adapter plates 40 for use with the meter replacement system 100, in accordance with the first exemplary embodiment of the present disclosure. Since conventional meters come in varying sizes and shapes, replacing them with a new meter often requires adapting the new meter to match the existing shape or space from which the old meter was removed, such that the new meter fits within the existing panel. The adapter plate 40 may help mount the single movement display meter 10 to the existing space from which the old, conventional meter was removed. However, because there are a vast number of sizes of conventional meters, it is difficult and impractical to have only a single adapter plate 40. Instead, the meter replacement system 100 utilizes a variety of adapter plates 40 with different sizes and configurations, but a standard sized central aperture 42, such that a single movement display meter 10 can be installed in place of virtually any conventional meter.

More specifically, the adapter plates 40, as shown in FIG. 6, each have a spatial footprint, i.e., length and width, which varies to match the footprint of an existing meter. In FIG. 6, the spatial footprints of the adapter plates 40 may range from 1.5 inches on each side to 4.5 inches on each side, however, any other dimension of the adapter plate 40 spatial footprint is also possible. Additionally, the adapter plates 40 may have varying bolt patterns to allow the adapter plate 40 to attach to an existing panel, a meter, or another structure, as may vary based on the design. Some bolt patterns may include four holes whereas other adapter plates 40 may include three holes. Each of the apertures 42 within the adapter plates 40 may be sized the same to receive the hub 30 (FIGS. 4-5). This allows one universal hub to fit within the vacated space of virtually any type of conventional meter.

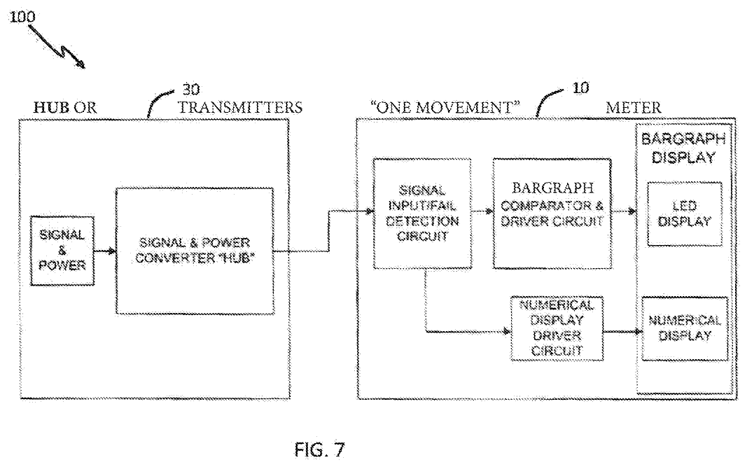

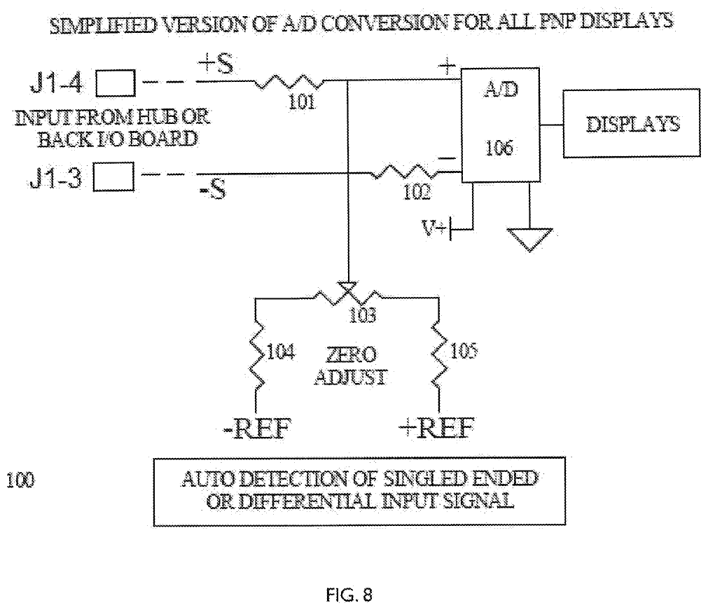

FIGS. 1-6 describe the mechanical components of the meter replacement system 100 which allows the efficient and convenient replacement of virtually any conventional meter with a new meter that can easily be mechanically adapted to fit within the space vacated by an old meter. FIGS. 7-14 describe the electrical adaptability of the meter replacement system 100, and in particular, the signal modification module 32.

FIG. 7 is a schematic diagram of the hub 30 and the single movement display meter 10, in accordance with the first exemplary embodiment of the present disclosure. As shown, at a general level, the hub 30 may receive both a hub input signal from a sensing device and a power input from a power supply. The hub input signal may be received from any type of sensor, monitor, or similar device which is capable of providing electrical signals for a meter to display, such as, for example, a thermometer, a pressure monitor, an electrical monitor, etc. The hub 30 converts the hub input signal into the appropriate format and transmits the display input signal and a power input to the meter 10. Commonly, irrespective of the type of hub input signal and power signal received at the hub 30, the hub 30 transmits a 0.5 v full scale signal and 3-5 v DC power to the single movement display meter 10. The single movement display meter 10 may receive the signals, process them through a detection circuit and various other circuits, and display the results, as is described in U.S. Pat. No. 10,222,405, for instance.

FIG. 8 is a simple schematic electrical drawing of the analog/digital conversion as applied to the present disclosure. This version differs from past designs by connecting the A/D converter on both the bar and digit displays in a differential mode to allow the selected signal/power conditioner installed in the hub 30 or I/O board to drive the display in “single ended”, for powered versions or “differential mode” when using current loop power to meet the “one movement” requirement, via connector J1 pins 1: (VCC), 2: digital ground, 3: − REF signal, and 4: + REF signal (See FIG. 8).

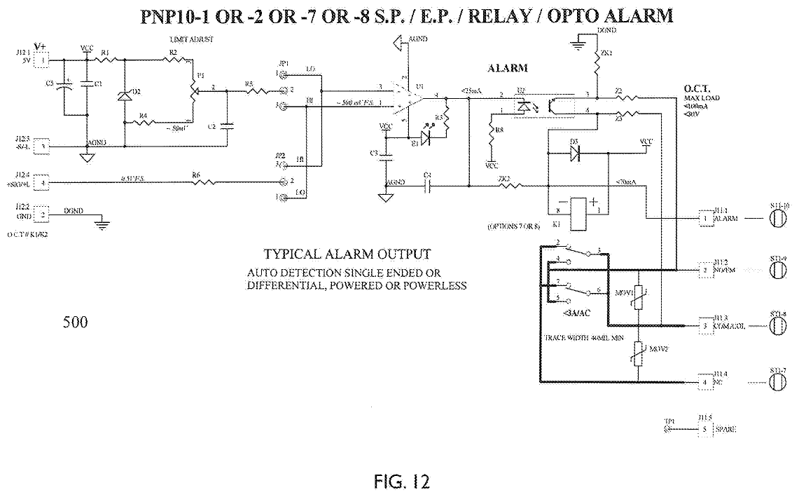

The displays (digits or bar) automatically detect whether the display input signal from the hub output port 36 is “single ended” (the negative input is grounded) or differential (both positive and negative inputs are floating) or the display input signal is negative as supplied by the hub output port 36 or input/output (I/O) module (FIG. 11) depending on the plugged module on socket SC-C or SC-D and plug-in jumpers JC and/or JD per instructions, eliminating the need for multiple specific input signal or power meters whether at the factory or the end user for emergency replacement. Further structure for this purpose is illustrated in FIG. 12.

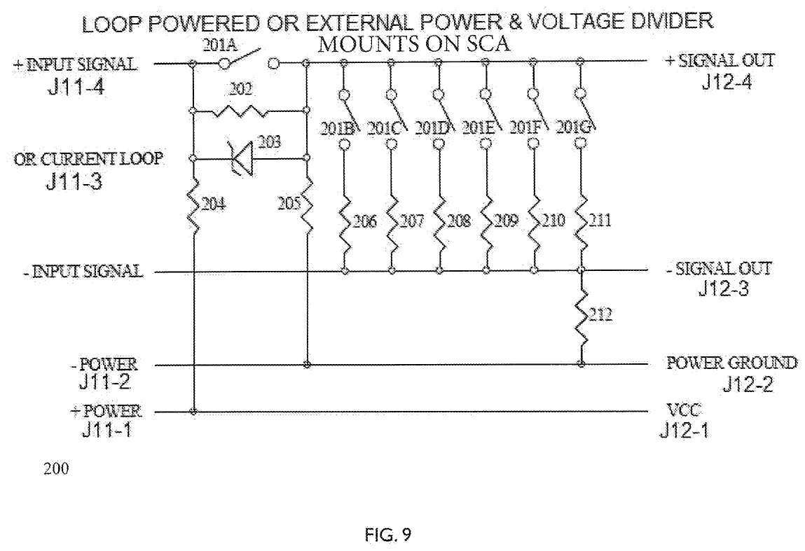

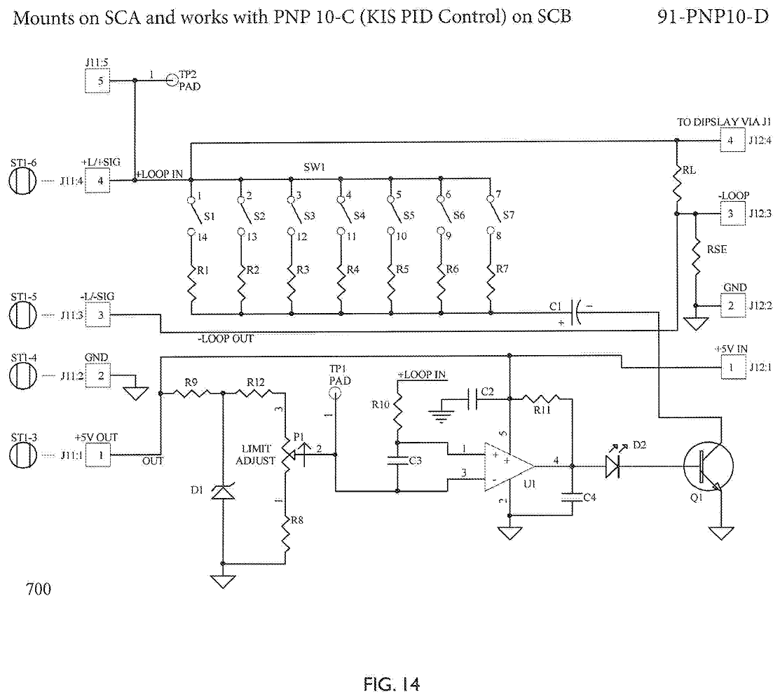

FIG. 9 is a simple schematic electrical drawing of a signal convertor as applied to the present disclosure. When utilizing current loop power, the +loop input is routed from connector ST1-6 on 91-PNP-F-1 to J11-4 (as illustrated in FIG. 14) through 91-PNP78-00 SW1-1 (closed), through switch 7 (closed) through R7 to 91-PNP-F-1 J11-3 and J12-3 (−signal out) to ST1-5 closing the current loop.

Since on 91-PNP78-00 “DL” is installed as well as RL1 and RL2, DL (reference) clamps the loop voltage to −4V a J11-4 and J11-1 (through RL2) and J12-1 to power the display through J1-1 (on 91-PNP-F-1 on −N-1) and return the current to switch 1 pin 7 to “SLIME” it after it has returned from the display (and other loads within the HUB) to −loop if and only if resistor RSE is absent, in other words: all loop current must flow through the entire circuit (display and signal conditioners plugged) to J11-3 and ST1-5 (−loop input) for accurate measurement and power of the display. The above is identical for either 4-20 or 10-50 mA current loops except for the value of R2 (10 Ohms) vs R7 (24.9 Ohms) to develop the full-scale signal of 0.5 Vdc (at 20 or 50 mA input) to be displayed. No other components are required for the “loop powered” mode.

Disclosures in co-owned prior patents are expanded here by including a field selectable signal conditioner for either current loop or externally power functionality of the display in the field (user) selectable function or input signal range as well as the compliance of configuring the signal for automatic differential or single ended requirement of the digital display 16.

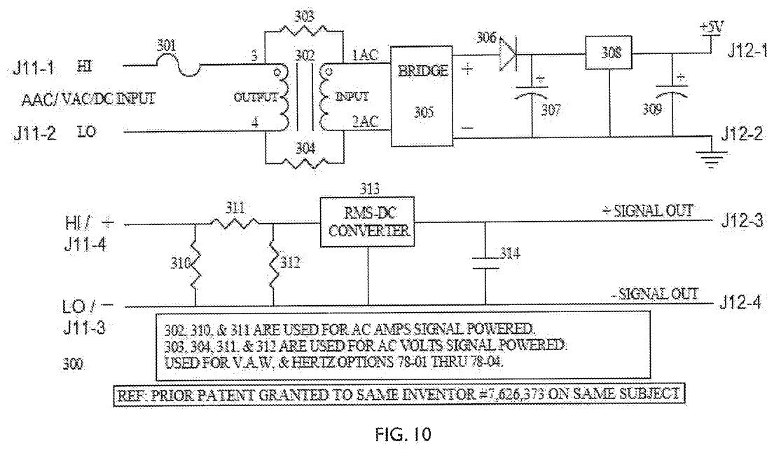

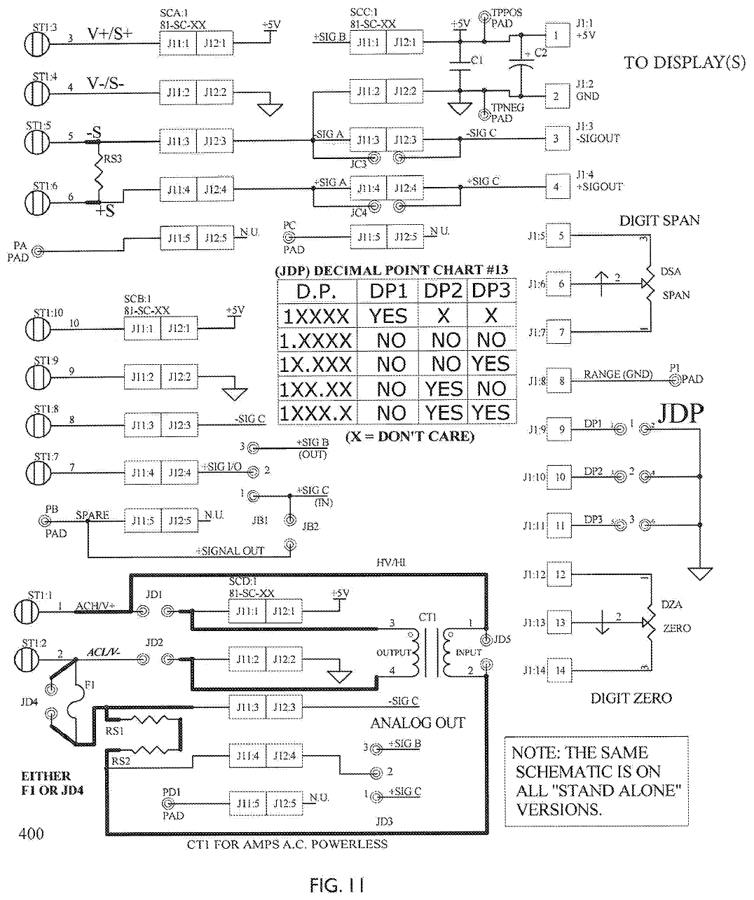

FIG. 10 is an illustration of a schematic for power conversion in accordance with the single movement meter system of the present disclosure. The signal modification module 32 may provide conversion from AC power input or from AC current input or both, as is illustrated in FIG. 10. Other power conversion designs are known to those having ordinary skill in the art and utilization of other known power conversion systems does not depart from the scope of the present disclosure.

FIG. 11 is an illustration of a schematic for an input/output module of the signal modification module 32. The system largely relies on the technology disclosed in U.S. Pat. No. 10,222,405, which is incorporated by reference herein in its entirety.

FIG. 12 is an illustration of a schematic for an automatic detection of either loop power (differential) or external power (single ended). The automatic detection is the connection that the selected signal conditioner on the hub 30 determines. In differential mode the −input signal swings from 0 to −0.5 Vdc and the comparator (U1) on FIG. 12 detects the differential or single ended mode via the status of J11-3 that controls U1 “ground” level of comparison and limit adjustment reference circuit (D2 and P1) must cover the entire range from 0 to −0.5 V FS and if externally powered from 0 to +0.5 V FS all under the control of resistor 212 or lack of it.

The opto isolated open collector transistor (U2) can be used as a stand-alone for light loads under 50 mA and under 30 VDC, or to drive the power relay (K1) for heavy loads. The comparator (U1) can drive H.V. MOSFETS (SSR) and reed relays while loop powered. The unique automatic detection of either single ended or differential status of the input signal allows the hub 30 to be able to drive loads even when powered by the hub input signal it measures.

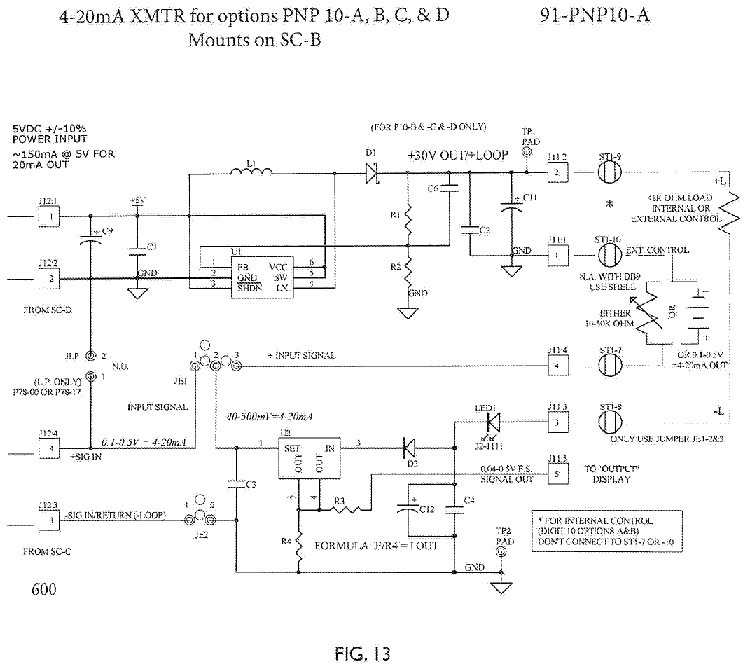

FIGS. 13 and 14 are illustrations of schematics for Proportional Integral Derivative (PID) modules. PID applications are niche technology and implement complex mathematical equations. The majority of the PID applications only requirement is to avoid an “over and under shoot” of the output to prevent damage due either to an overload or slow process reaction to the input applied.

FIG. 13 is a PID module whose output is controlled by the user's “derivative” input signal (limit) either 0.1-0.5 Vdc (for 4-20 mA output) at ST1-7 (+) and ST1-8 (−) or 10K-50K Ohms input signal (at the same terminals as above) if jumpers JE1-2 and 3 are plugged. As shown in FIG. 13, the selected display is connected in “series” with a user's load ST1-8 to ST1-6 (+loop input to display), ST1-5 −loop to customer's +load and customer's −load to ST1-9, to monitor the actual output of the transmitter into the user's load. This section is known as the “empirical derivative” under the control of the user.

As illustrated in FIG. 14, the “proportional” and “integral” variables selected empirically (experimentally) by the user by selecting the desired integral (integration of the current loop output) with SW1 rockers 1-6 for desired time constant (charging of C1) “derivative” (time/level) to slow down (charging of C1) via a signal level “trip point” of U1 when its output (pin 4) “grounds” the negative input of C1. The charging of C1 is controlled by the comparator U1 and selected by the user via potentiometer P1 that sets the “trip point” of U1 when its terminal 3 exceeds the value of terminal 2 (set point) to start charging C1. The user selects the time constant desired based on its unique process delayed reaction to its control input signal (the current loop output of the transmitter as described above) by selecting the trip point of the comparator U1 via potentiometer P1, so when the current loop value at J11-4/J12-4 (+loop in) at U1-3 exceeds U1-1, U1 will ground the negative input of C1 beginning the integration (slow down) cycle of the PID.

The super capacitor C1 along with the selected series resistor (R1-R5) determines the “time constant” of the “forced” delay on the output current loop at ST1-8 (+loop out) and ST1-6 (+loop in of the KISPID and display via J12-4) and its output at ST1-5 (J12-3) that becomes the user's+loop in to control its process. In other words, this PID is a user's selectable “time delay” to prevent an over or under shoot to allow the driven process to “react” to the hub input signal, eliminating this over or under “shoot.” It should be noted that this PID module is developed without any software. As a hardware-only system, it does not rely on memory devices or require software upgrades.

For experimental purposes (learning how the specific user's process reacts to the optimum time delay [by C1 and R1-R5], SW1-7 is used to force C1 [0.1 FARAD] to discharge instantaneously).

The limit adjust of U1 via P1 is typically set at −90-95% of full scale to enable C1 to charge through SW1-1 through -5 for desired time constant of 10-100 seconds with any other ranges selected by changing the values of R1-R5.

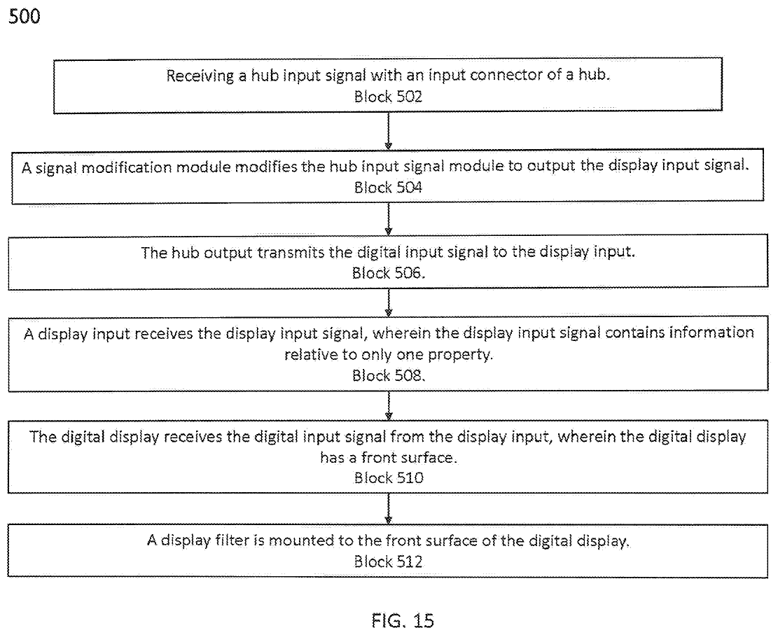

FIG. 15 is a flowchart 500 illustrating a method of operating a single movement display meter in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 502, the process begins by receiving a hub input signal with an input connector of a hub. A signal modification module modifies the hub input signal module to output the display input signal (block 504). The hub output transmits the digital input signal to the display input (block 506). A display input receives the display input signal, wherein the display input signal contains information relative to only one property (block 508). The digital display receives the digital input signal from the display input, wherein the digital display has a front surface (block 510). A display filter is mounted to the front surface of the digital display (block 512).

Any number of additional steps, functions, processes, or variants thereof may be included in the method, including any disclosed relative to any other figure of this disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A single movement display meter comprising:
a display input wherein the display input receives a display input signal containing information relative to only one property;
a digital display positioned to receive the display input signal and represent the digital input signal within a display, wherein the digital display has a front surface; and
a display filter mounted on the front surface of the digital display.

2. A single movement display system, comprising:
a single movement display meter comprising:
a display input wherein the display input receives a display input signal containing information relative to only one property;
a digital display positioned to receive the display input signal and represent the digital input signal within a display, wherein the digital display has a front surface;
a display filter mounted on the front surface of the digital display; and
a hub, the hub comprising:
an input connector connectable to one or more wires to receive a hub input signal;
a signal modification module capable of modifying the hub input signal to output the display input signal; and
a hub output in communication with the display input to transmit the display input signal.

3. The single movement display system of claim 2, further comprising a power connection between the hub and the digital display, thereby powering the digital display.

4. The single movement display system of claim 2, further comprising a rigid mechanical connection between the hub and the single movement display meter,

5. The single movement display system of claim 2, further comprising an adapter plate having an opening therethrough, wherein the hub is received within the opening and attached to the adapter plate.

6. The single movement display system of claim 4, further comprising an adapter plate having an opening therethrough, wherein the hub is received within the opening and attached to the adapter plate.

7. The single movement display system of claim 3, wherein the hub input signal is manipulated to provide power for the power connection and to create the display input signal.

8. The single movement display meter of claim 1, wherein the display is monochromatic and changeable between multiple colors.

9. The single movement display meter of claim 1, wherein the display filter is adhesively attached to the front surface of the digital display.

10. The single movement display meter of claim 1, wherein the display filter is mechanically attached to the front surface of the digital display.

11. A method of operating a single movement display meter, the method comprising the steps of:
receiving a display input signal with a display input, wherein the display input signal contains information relative to only one property;
receiving the digital input signal from the display input with the digital display, wherein the digital display has a front surface; and
mounting a display filter to the front surface of the digital display.

12. The method of claim 11, further comprising the steps of:
receiving a hub input signal with an input connector of a hub;
modifying the hub input signal with a signal modification module to output the display input signal; and
transmitting the digital input signal from a hub output to the display input.

13. The method of claim 12, wherein the step of modifying further comprises converting the hub input signal into a power supply and the display input signal; and further comprising transmitting the power supply to the digital display.

14. The method of claim 12, further comprising mechanically connecting the hub and the single movement display meter.

15. The method of claim 12, further comprising manipulating the hub input signal to provide power to the digital display.
